(19) United States
(12) Patent Application Publication
(10) Pub. No.: US 2007/0041764 A1
(43) Pub. Date: Feb. 22, 2007

(54) Imprinting first side/back side of sheets

(76) Inventors: Stephan W.E. Pareigis, Molfsee (DE); Uwe Weinlich, Kiel (DE)

Correspondence Address: PATENT LEGAL STAFF, EASTMAN KODAK COMPANY, 343 STATE STREET, ROCHESTER, NY, 14650-2201, US

(21) Appl. No.: 10/569,356

(22) PCT Filed: Aug. 24, 2004
(86) PCT No.: PCT/US04/27502

§ 371 Date: Oct. 4, 2006

(30) Foreign Application Priority Data
Aug. 25, 2003 (DE) 103 38 949.0

(51) Int. Cl. G03G 15/00

(52) U.S. Cl. 399/401

(57) ABSTRACT

More even utilization of a printing machine, whereby a closed turnover loop that is used has the capacity to handle only a certain number of sheets. For one loading, the turnover loop is loaded as a sequence with a group Gₛ of a number x of sheets to be imprinted with first form printing to be loaded alternately with a group G_{w} of a number y of sheets to be imprinted with back side printing, and that in the loading of the turnover loop that directly follows, the sheets to be imprinted are loaded in a sequence that is conjugated with the preceding loading.

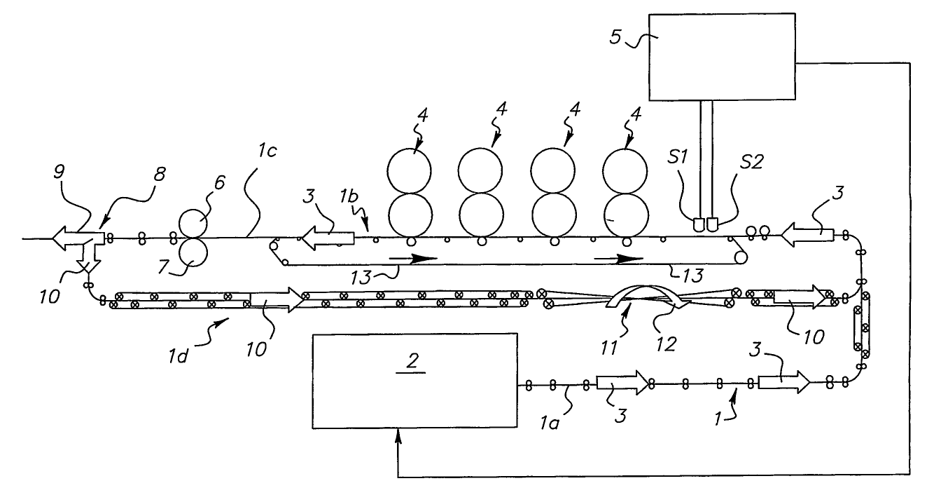

### FIELD OF THE INVENTION

The invention pertains to a process for imprinting sheets with the first form imprint on their front sides and with the back side imprint on their back sides using at least one printing unit, but preferably using several printing units for color printing, whereby the sheet that is to be imprinted is, in each case, first fed at least to the one printing unit for imprinting the first form imprint and is then once again fed via a turnover loop (closed) at least to the one printing unit for imprinting the back side imprint, whereby the turnover loop can be fully loaded with a number of sheets, and whereby this number is an even whole number.

### BACKGROUND OF THE INVENTION

If a sheet that has writing on both the front side and the back side (the original) is to be copied in a copying machine, and if such copy is to be printed on both sides, then the copy is imprinted with an electrophotographic first form imprint and a back side imprint (duplex printing), for the purpose of which the copy sheet is usually turned over immediately after the first form imprint with the use, for example, of a turnover bin or the like, and then the back side imprint is imprinted on the back side. With regard to this process, let “first form imprint” mean the first imprint on a leaf or a sheet, whereby the “front side” of the leaf or the sheet can be defined as such by this first form imprint. In this sense, then it would contradict the chosen definition and it would, to this extent, be logically impossible to imprint the back side of a leaf or a sheet first.

In a printing machine, which is intended to process a large printing assignment (job) with printing on both sides of the sheets, one can first print a large group of sheets (batch) with the first form imprint and then turn this entire group over by a closed turnover loop and return it for the back side imprint before these sheets that have now been printed on both sides S are discharged on the distributor side of the printing machine, and the next group of sheets is inserted into the once again empty turnover loop. In this process, the entire sheet-loading capacity of the closed turnover loop is used each time to the greatest extent possible. For this purpose, the entire length of the turnover loop is, for example, divided in its configuration or by software into an integral number of sheet-holding areas, whereby the dimension of each of these sheet-holding areas is such that the area could even hold a differently formatted sheet. Correspondingly, the cycle time of the turnover loop or of a conveyor belt that, for example, runs through the turnover loop could, while taking into account the length of the loop or of the belt, be sub-divided into the appropriate even whole number of so-called time windows (frames). In this process, the sheets that are being conveyed in the turnover loop are detected, for example, at a particular place by a leading edge sensor that recognizes the leading edge of the sheet. This sensor can be beneficially located at the point at which a path for the sheets that leads from a feeder into the turnover loop merges into the turnover loop.

The characteristics of a so-called “batch mode,” for example, are explained in U.S. Pat. No. 4,488,801.

Because of the constant loading and emptying of the turnover loop, undesirable dead times arise such that (1) the printing machine is not optimally engaged with respect to time, and (2) the machine does not become adjusted to an even temperature distribution. In this regard, it must be taken into account that the closed turnover loop can have a capacity that permits it to accept a two-figured number of sheets in order, for example, to process a printing assignment in which one print job, for example a brochure, can consist of one hundred leaves.

A more even utilization of the printing machine can alternatively be achieved if each time a sheet that must still be imprinted on the back side always alternates in the turnover loop with a sheet that has not yet been imprinted on the first form side. This means that a newly arrived sheet must be fed into a space between two already imprinted sheets (interleaved), i.e., that the turnover loop is constantly loaded with alternating first form side sheets and back side sheets.

If, however, the number of sheets which the turnover loop can hold is an even number, an alternating sequence of a front sheet and then a back sheet does not serve the purpose because, as the process progresses, problems arise to the extent that a front sheet (front: F) that has been imprinted with the first form imprint would not, after passing through the turnover loop and being turned over so as to become a back sheet (back: B), does not end up behind a front sheet, but rather behind a sheet back side, so that the alternating sequence of the sheets would quickly be broken. It is not possible to maintain the sequence of F-B-F-B-F . . . F for loading the turnover loop unless the number sheets which the turnover loop can handle is uneven.

### SUMMARY OF TEE INVENTION

The objective of the invention is to make possible a more even utilization of a printing machine by the use of a process, whereby the closed turnover loop for imprinted sheets has the capacity to handle only a certain number of sheets. This objective is achieved by (1) for the initial loading, the turnover loop is sequentially loaded with a group Gₛ of sheets to be imprinted with the first form imprint and having the number x, alternating with a group G_{w} of sheets to be imprinted with the back imprint and having of the number y, and (2) for the very next loading of the turnover loop, the sheets to be printed are loaded in a sequence that is conjugated with the preceding loading in the sense that, in place of the x sheets of each group Gₛ of the preceding loading, now x sheets of a group G_{w} are placed, and in place of the y sheets of each group G_{w} of the preceding loading, sheets of each group Gₛ are placed.

In this beneficial way, a kind of grouped, interleaved process is achieved by which a printing machine can be beneficially evenly utilized according to the invention, whereby, in addition, a certain periodicity of the sheet sequencing can be realized, and consequently control of the sheet feed can be achieved relatively simply.

Of course, it can be beneficial in an initial run or a re-run or when beginning a print job, if one does not completely load the turnover loop, particularly for the first one or two loadings of the turnover loop, and instead perhaps loads it for the time with only a few sheets. This approach will above all provide time for the initial screenings of the print images for the initial sheet imprintations, before the printing machine is then fully loaded and screenings that are subsequently required can be handled by the software simultaneously with the ongoing printing events related to the previously screened print data.

Consequently, according to further developments of the invention, provision is preferably made that for an initial run or a re-run of a printing machine that is operating in accordance with the process according to the invention, particularly, however, for the initial loading or the first couple of loadings of the turnover loop, the turnover loop should be loaded less than completely using a number of sheets that is less than its maximal holding capacity, and that preferably for the aforementioned initial loading only (x or y) sheets of at least one group Gₛ be placed and that the areas that are actually available for sheets of at least one group G_{w} remain empty.

Also, in addition, the second loading could beneficially be conjugated, in that the second loading that immediately follows the first loading is conjugated with the first loading in the sense that in the place of the (x or y) sheets of each group Gₛ of the preceding first loading, now the same number (x or y) of sheets of a group G_{w} is placed and the areas that remained empty during the first loading also remain empty during the second loading.

According to another further development of the invention, a turnover loop is used in which, in particular, the number of sheets, which the turnover loop can handle equals 18, and the number of the group size equals 2 or 6.

Of course, provision can also beneficially be made for using a turnover loop with a capacity of a number of frames that is not unevenly divisible. For example, the number could equal 16. In such case, groups Gₛ and G_{w} would be provided, in which the numbers x and y of sheets in these groups would not be equal, but would instead possibly be even extremely different. For example, provision could be made for only one group Gₛ, with a number x=2 sheets, and only one group G_{w}, with a number y=14 sheets, or, conjugated for this purpose in the second loading, a group G_{w} with a number x=2 sheets and only one group Gₛ, with a number y=14 sheets, in order to fully load a turnover loop with a capacity equal to 16.

Additional characteristics, which are not, however, intended to limit the invention, can be found in the description of the drawing.

### BRIEF DESCRIPTION OF THE DRAWINGS

An embodiment of a travel path through an electrophotographic printing machine, which does not, however, limit the scope of the invention, is shown schematically in a side view and only as an example in the single drawing that is attached hereto.

### DETAILED DESCRIPTION OF THE INVENTION

The travel path 1 begins at a feed unit, or two or more feed units, which are shown schematically all together simply as block 2. From there, sheets are fed into the travel path in the direction shown by the arrow 3, i.e., in particular, the feeding of sheets starts at a particular starting time. A first section of the travel path 1a ends upstream of a continuous conveyor belt that forms a second section of the travel path 1b and onto which the sheets are delivered so that they can pass through a printing unit, which in this case has four color printing mechanisms 4.

Two sensors S1 and S2 are mounted essentially in the transition area between the first section of the travel path 1a and the second section of the travel path 1b. The sensor S1 detects a cross-seam of the conveyor belt 1b that serves as a marker in the conveyor belt. The sensor S2 detects the arrival of a sheet in its area. Both sensors are connected to a control mechanism 5, which for its part influences the feed unit or feed units 2 according to the invention, beneficially using the data coming from the sensor S2, while also taking into account the data from sensor S1 to determine or correct a start time for at least the next sheet that is to be started from the feed unit 2.

After the sheets have passed the print mechanisms 4 and their front sides have been imprinted, the sheets, after transiting onto a third section of the travel path 1c, are fed to a fuser mechanism that includes a fuser roller 6 and pressure roller 7. After fusing has taken place, the sheets reach a switching point in the path 8. Sheets that are to be printed on only one side are further conveyed in the direction of the arrow 9 to a delivery point not shown in the drawing. Sheets that are to be printed on both sides are guided in the direction of the arrow 10 into a return path 1d. This path conveys the sheets back to the area of sensors S1 and S2 upstream of the printing unit. This path incorporates a turnover mechanism 11, which turns the sheets 180° around their longitudinal axes, as indicated by the arrow 12. An empty stretch of the continuous conveyor belt moves in the direction shown by the arrow 13.

If the point where the section 1d of the travel path joins with the section 1a of the travel path is designated by the number 14, then the closed turnover loop used for imprinting both sides of sheets runs through this point of juncture 14 and the switching point in the path 8 (in the direction of the arrow 10), and also through sections of the travel path 1b and 1d, and that part of the section of the travel path 1a which, from the point of juncture 14 to the beginning of the section of the travel path 1b in the vicinity of the sensors S1 and S2, is combined with the section of the travel path 1d.

Based upon this information, a “duplex cycle time” can be defined as the time that a sheet is required to travel from the sensor S2 through the entire turnover loop and back to the sensor S2. This cycle time can be measured in time windows or frames. The size of a frame is then the duplex cycle time divided by a whole number b, which can be called the “batch size” (of the turnover loop). This size b can, for example, be 16 or 18.

If one designates the front side of a sheet with the letter F (front) and the back side with the letter B (back), as already mentioned above, then according to the invention, the batch size b of a turnover loop, which can, for example, be 18, will be filled with groups of sheets, in which the group size is n=2 or 6. This means that in one cycle the sheets will be fed to the turnover loop in a sequence:
a) FF-BB-FF-BB-FF-BB-FF-BB-FF or
b) FFFFFF-BBBBBB-FFFFFF
   and in the next cycle the sheets will be fed to the turnover loop in a “conjugated” sequence:
a) BB-FF-BB-FF-BB-FF-BB-FF-BB or
b) BBBBBB-FFFFF-BBBBBB.

“Conjugated” means that front sides F and back sides B are always interchanged, which means that in the frames during which paper is newly fed into the turnover loop (interleaved) during the first cycle, feeding pauses are inserted in the second cycle, and that, conversely, in the frames in which feeding pauses were present in the first cycle, now after imprinting on the back side has been completed in the first cycle, new sheets will be fed into the turnover loop for the second cycle.

The described process delivers an interference-free stream of sheets past the sensor S2, which can always be easily recognized by the above sequences a) and b), because the first cycle with F sheet ends, and the second cycle with B sheets begins seamlessly, and a third cycle that, like the first cycle, involves F sheets and begins after the second cycle with B sheets has ended, and so forth.

For a turnover loop with a capacity of, for example, b=16, the sequence of the sheets could, as indicated above, be quite different. For example, the turnover loop could be far less than fully loaded for the first two loadings, in order to gain time before the printing machine is fully utilized. In this regard, frames that did not contain sheets could be identified with a 0, such that the first two loadings could look like the following:
1. FF-00000000000000
2. BB-00000000000000 or even BB-FFFFFFFFFFFFFF
   The subsequent loadings could then, respectively, look like this:
3. a) FF-BBBBBBBBBBBBBB and
b) BB-FFFFFFFFFFFFFF.
Of course, other loadings with different sheet sequences are also conceivable. In particular, the third loading could also look like the first loading and then the fourth loading would look like the 3. b) loading, and that would be followed by the 3. a) loading as the beginning of an alternating interchange of 3. b) and 3. a) loadings.

1. A process for imprinting sheets with first form imprints on their front sides and with back side imprints on their back sides with at least one printing unit, but preferably several printing units for color printing, whereby said sheet to be imprinted in each case is first fed to said at least one printing unit to be imprinted with said first form imprint and is then again fed via a closed turnover loop to said at least one printing unit to be imprinted with said back side imprint, whereby said turnover loop can be fully loaded with a number b of sheets, and whereby this number b is preferably an even, whole number, characterized by said fact that for one loading, said turnover loop is loaded as a sequence with a group Gₛ of a number x of sheets to be imprinted with first form imprint to be loaded alternately with a group G_{w} of a number y of sheets to be imprinted with back side imprint, and that, in said loading of said turnover loop that directly follows, said sheets to be imprinted are loaded in a sequence that is conjugated with said preceding loading, in the sense that in place of said x sheets of each group Gₛ of said preceding loading, now x sheets of a group G_{w} are placed, and in place of said y sheets of each group G_{w} of said preceding loading, y sheets of a group Gₛ are placed.

2. A process according to claim 1, characterized by said fact that for an initial run, or re-run, of a printing machine operating with said process, for said first loading or said first two loadings of said turnover loop, said turnover loop is only partially loaded, using a number of sheets that is smaller than the maximum holding capacity of said turnover loop.

3. A process according to claim 2, characterized by said fact that for said aforementioned first loading only (x or y) sheets of at least one group Gₛ are placed and said areas that are otherwise available for sheets of at least one group G_{w} remain empty.

4. A process according to claim 3, characterized by said second loading that follows directly after said first loading is conjugated to said first loading in the sense that in place of said (x or y) sheets of each group Gₛ of said preceding first loading now said even number (x or y) of sheets of a group G_{w} is placed and said areas that remained empty in said first loading continue to remain empty in said second loading.

5. A process according to claim 1, characterized by said groups Gₛ and G_{w} each include an equal number of n sheets (n=x=y), whereby this number n is a whole number which unequally divides said number b.

6. A process according to claim 5, characterized by said fact that said number b equals 18 and said number n is chosen to equal 2 or 6.
